(19) United States
(12) Patent Application Publication
(10) Pub. No.: US 2016/0027568 A1
(43) Pub. Date: Jan. 28, 2016

(54) AIR-COOLED REACTOR

(71) Applicant: MITSUBISHI ELECTRIC CORPORATION, Chiyoda-ku, Tokyo (JP)

(72) Inventors: Daisuke TAKAUCHI, Chiyoda-ku, Tokyo (JP); Hajime NAKATANI, Chiyoda-ku, Tokyo (JP); Kazutoshi KURAHASHI, Chiyoda-ku, Tokyo (JP)

(73) Assignee: MITSUBISHI ELECTRIC CORPORATION, Chiyoda-ku, Tokyo, OT (JP)

(21) Appl. No.: 14/772,713

(22) PCT Filed: Jul. 18, 2013
(86) PCT No.: PCT/JP2013/069488

§ 371 Date: Sep. 3, 2015

(51) Int. Cl. H01F 27/08

(52) U.S. Cl. CPC H01F 27/085

(57) ABSTRACT

This invention is provided with: a wind tunnel that, while keeping an insulating distance to pair-forming coils, surrounds a region from a yoke portion of a core to at least a part of the pair-forming coils, to thereby guide a flow of cooling air for the pair-forming coils into an extending direction of leg portions; a supporting structural member that is fixed to the yoke portion to support inside the wind tunnel, the core and the pair-forming coils; and a windshield plate that partly shields a gap between the pair-forming coils and the wind tunnel; wherein, in the supporting structural member, air holes for passing the cooling air therethrough are formed in corresponding to inner gaps of the coils.

### TECHNICAL FIELD

The present invention relates to a configuration of an air-cooled reactor, and in particular, relates to a large-capacity and high-voltage air-cooled reactor which is used for an ozone generator or the like.

### BACKGROUND ART

While reactors are passive elements using inductors, in order to suppress temperature rise due to heat generation, air-cooled reactors whose coils are cooled by cooling air are used, for example, in large capacity applications. Meanwhile, in cases of cooling by use of a coolant such as cooling air, for the purpose of enhancing cooling efficiency, such a structure is adopted in many cases that enhances the flow speed without increasing the flow volume by the provision of a shielding member, a partition or the like (see, for example, Patent Documents 1 to 3).

In this respect, there is disclosed such a cooling structure in which, with respect to a reactor used for a semiconductor device, a cylindrical air-flow guide is formed along the outer circumference of the coil portion thereof and a windshield plate is formed between the air-flow guide and the inner wall of the housing, to thereby ensure the flow speed of the cooling air at the outer circumference of the coil portion (see, for example, Patent Document 4).

### CITATION LIST

### Patent Document

Patent Document 1: Japanese Patent Application Laid-open No. H08-325002 (Paragraphs 0011 to 0013, FIG. 1)
Patent Document 2: Japanese Patent Application Laid-open No. 2002-255513 (Paragraphs 0032 to 0034, FIGS. 1 to 5)
Patent Document 3: Japanese Patent Application Laid-open No. 2006-187062 (Paragraphs 0017 to 0024, FIGS. 1 to 3)
Patent Document 4: Japanese Patent Application Laid-open No. H04-216605 (Paragraphs 0009 to 0013, FIG. 1, FIG. 2)

### SUMMARY OF THE INVENTION

### Problems to be Solved by the Invention

However, according to the aforementioned reactors, since the cooling air is supplied from an air inlet formed on a side surface of the housing, a deviation in flow occurs along the circumference direction of the coil, so that cooling becomes insufficient, and thus, it is difficult to fully exert its ability. Further, even if an air inlet could be formed on the bottom surface, when this is to be applied, for example, to a large capacity reactor such as for an ozone generator, a supporting structural member connected to the core of the reactor for supporting its weight, serves as an obstacle to thereby interrupt the flow of the cooling air toward the central region. Thus, even if a deviation along the circumference direction could be improved by use of the windshield plate as shown in Patent Document 4, or the like, a deviation occurs along the radial direction, so that it is difficult to cool inside portions.

This invention has been made to solve the problems as described above, and an object thereof is to provide an air-cooled reactor which can lessen the deviation of the cooling air along the radial direction of the coil and thus, can be cooled efficiently.

### Means for Solving the Problems

The air-cooled reactor of the invention is characterized by comprising: a core having mutually-facing leg portions with an interval therebetween and yoke portions that connect together respective both ends of the mutually-facing leg portions; coils that form a pair and are so placed as to surround the mutually-facing leg portions respectively; a wind tunnel that, while keeping an insulating distance to the pair-forming coils, surrounds a region from one of the yoke portions to at least a part of the pair-forming coils, to thereby guide a flow of cooling air for the pair-forming coils into an extending direction of the leg portions; a supporting structural member that is fixed to said one of the yoke portions to support, inside the wind tunnel, the core and the pair-forming coils; and a windshield plate that partly shields a gap between the pair-forming coils and the wind tunnel; wherein, in the pair-forming coils, inner spaces are formed respectively between the coils and the leg portions or inside of the coils, that extend in the extending direction of the leg portions; and wherein, in the supporting structural member, air holes for passing the cooling air therethrough are formed corresponding to the inner spaces.

### Effect of the Invention

According to the air-cooled reactor of the invention, since the air holes are formed in the supporting structural member that supports the core and the coils, the cooling air also flows inside the coils, so that it is possible to provide an air-cooled reactor which can lessen the deviation of the cooling air along the radial direction of the coils and thus, can be cooled efficiently.

### BRIEF DESCRIPTION OF THE DRAWINGS

FIG. 1 is a partly cut-away front view of portions inside a wind tunnel of an air-cooled reactor according to Embodiment 1 of the invention.

FIG. 2 is a side view of the portions inside the wind tunnel of the air-cooled reactor according to Embodiment 1 of the invention.

FIG. 3 is a sectional view of the portions inside the wind tunnel of the air-cooled reactor according to Embodiment 1 of the invention, viewed from the upper side.

FIG. 4 is a partial bottom view of the air-cooled reactor according to Embodiment 1 of the invention.

FIG. 5 is a top view of the air-cooled reactor according to Embodiment 1 of the invention.

FIG. 6 is a top view of an air-cooled reactor according to Embodiment 2 of the invention.

FIG. 7 is a sectional view of the air-cooled reactor according to Embodiment 2 of the invention, viewed from the front side.

FIG. 8 is atop view of an air-cooled reactor according to Embodiment 3 of the invention.

FIG. 9 is a sectional view of the air-cooled reactor according to Embodiment 3 of the invention, viewed from the front side.

FIG. 10 is a top view of an air-cooled reactor according to Embodiment 4 of the invention.

FIG. 11 is a sectional view of the air-cooled reactor according to Embodiment 4 of the invention, viewed from the front side.

### MODES FOR CARRYING OUT THE INVENTION

### Embodiment 1

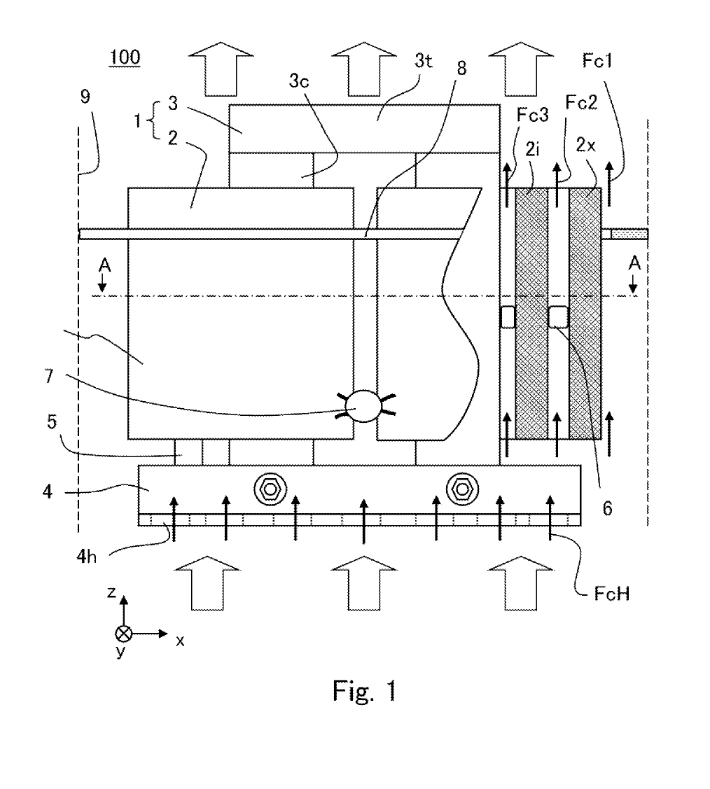

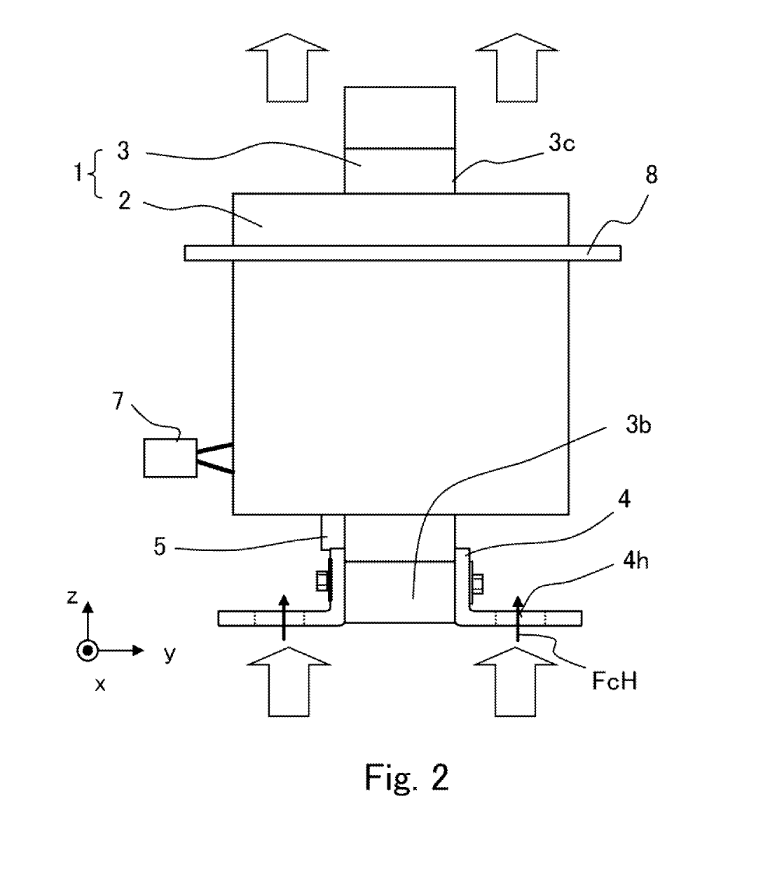

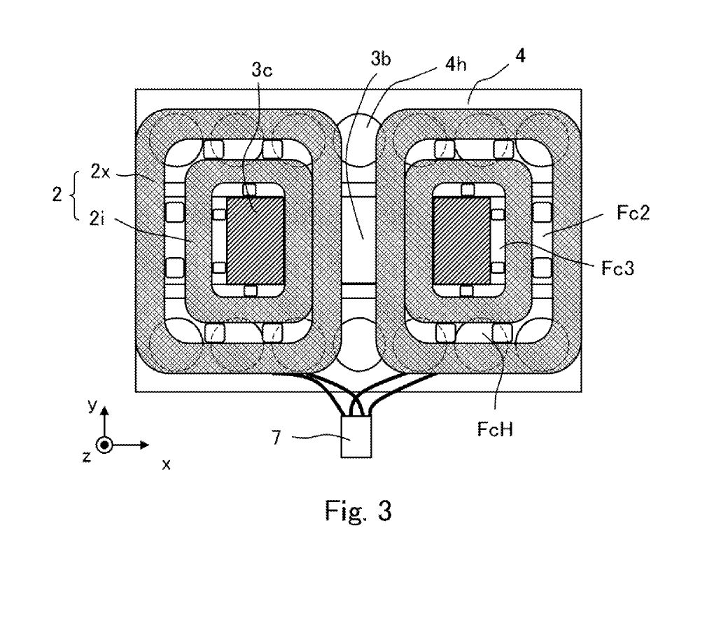

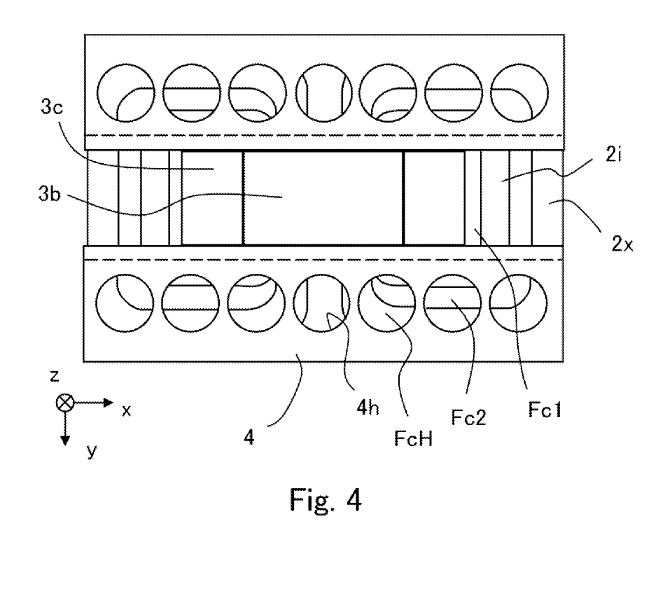

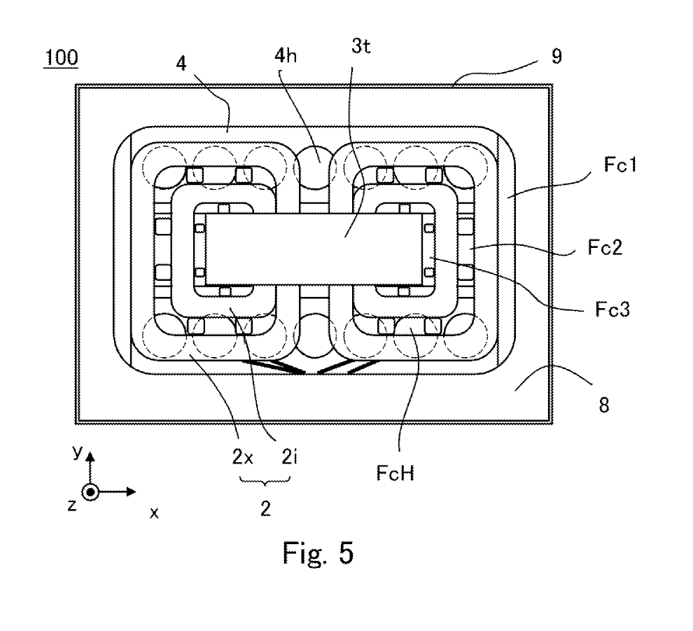

In the followings, the configuration of an air-cooled reactor according to Embodiment 1 of the invention will be described. FIG. 1 to FIG. 5 are for illustrating the air-cooled reactor according to Embodiment 1 of the invention, in which FIG. 1 is a front view of portions inside a wind tunnel of the air-cooled reactor assuming that a coil in the right side is partly cut away; FIG. 2 is a side view of the portions inside the wind tunnel of the air-cooled reactor; and FIG. 3 is a sectional view according to the line A-A in FIG. 1, which is a sectional view of the portions inside the wind tunnel of the air-cooled reactor when viewed from the upper side. Further, FIG. 4 is a bottom view of a reactor portion and a supporting structural member-portion in the air-cooled reactor, and FIG. 5 is a top view of the air-cooled reactor.

Reactors are obtained such that coils that form a pair are so placed as to surround mutually-facing leg portions of a looped core, respectively. Further, with respect to a reactor, for example, for an ozone generator, that is required to have a high voltage as high as several kV and a capacity as large as several tenths A (amperes), only the core and its coil portion that are main members (reactor portion) result in a weight as high as several tenths kg, so that it is required to have an air-cooling structure for removing heat generated.

In an air-cooled reactor 100 according to Embodiment 1, as shown in FIG. 1 to FIG. 5, a core 3 also forms a looped shape by comprising respective leg portions 3c that are mutually facing and extending in the vertical direction, and a yoke portion 3t (top side) and a yoke portion 3b (bottom side) that connect the two leg portions 3c at their upper side and their lower side, respectively. Further, coils 2 that form a pair are so placed as to surround the leg portions 3c of the core 3, respectively, and are each separated into a plurality of layers 2x, 2i so as to form a space thereinside. Further, just like a general air-cooled reactor, for ensuring insulation and for cooling, between the coils 2 and the core 3 and between the layers 2i, 2x of each coil 2, a plurality of spacers 6 are placed so that spaces (flow passages Fc2, Fc3) that make communication in the vertical direction (z-direction) are ensured. Meanwhile, in order to guide the cooling air in the vertical direction, as shown in FIG. 1 and FIG. 5, a wind tunnel 9 is formed so as to surround a reactor portion 1 (core 3 and both coils 2), so that a flow passage Fc1 that makes communication in the vertical direction is formed between the reactor portion 1 and the wind tunnel 9. Further, an unshown fan is placed at the top, thus providing such a configuration in which the cooling air flows upward in the respective flow passages Fc1 to Fc3.

Furthermore, since the reactor portion 1 itself is large in weight, as shown in FIG. 1 and FIG. 2, there are provided: a supporting structural member 4 that is joined to the yoke portion 3b of the core 3 to be kept to the ground voltage, and that causes the reactor portion 1 to self-stand thereon; and coil supporting members 5 that are placed between the coils 2 and the supporting structural member 4, and that support the self weights of the respective coils 2. Note that the supporting structural member 4 is fixed through an unshown pedestal to an unshown housing (will be described in Embodiment 2 or later) placed outside the wind tunnel 9.

Note that, with respect to the spaces (flow passages) inside each of the coils 2, the number thereof may be increased/decreased as appropriate according to the number of coils; however, for simplifying the description, in the figures, such a case is shown in which the number of coil layers are two, by the inner layer 2i and the outer layer 2x. Note that, from the respective coils 2, terminals for electrical connection are drawn out, which are then collected in a connector 7.

Here, the most distinctive feature of the air-cooled reactor 100 according to Embodiment 1 of the invention resides in the provision of a windshield plate 8 for narrowing a gap of Fc1 between the wind tunnel 9 that surrounds all around the reactor portion 1 and the outer surface of the reactor portion 1, and in the formation of air holes 4h in the supporting structural member 4 so as to ensure an air flow to the flow passages Fc2, Fc3 inside the coils 2.

In a reactor with high-voltage specification, such as, for an ozone generator, in order to ensure an insulating distance (spatial distance), it is necessary to keep the interval between the wind tunnel 9 and the reactor portion 1 (to be exact, the outer circumference of the coils 2) to a specified distance or more. Thus, if there is no windshield plate 8, the passage resistance of the flow passage Fc1 at the outer-circumference side of the coils 2 becomes predominantly lower than the passage resistance of the flow passages Fc2, Fc3 inside the coils 2, so that almost all cooling air flows toward the flow passage Fc1 at the outer-circumference side of the coils 2. Note that if the wind tunnel 9 is formed of an insulating material, the interval can be narrowed; however, because of difficulty in fabrication and in consideration of cost etc., it is practical to fabricate it using a metal being a conductor. For that reasons, there is formed the windshield plate 8 that is made of an insulating material and can be formed in a simplified shape, such as a picture frame, to thereby enhance the passage resistance of the flow passage Fc1 so as to optimize the distribution of the passage resistances of the respective flow passages Fc1 to Fc3.

Meanwhile, as described previously, in a large-weight reactor, such as, for an ozone generator, the supporting structural member 4 for supporting the reactor portion 1 becomes necessary. Thus, even if, as in a conventional case, an air-flow guide or windshield plate is simply formed around the coils 2 to thereby lower the passage resistance of the passages Fc2 and Fc3 relatively to the flow passage Fc1, it is difficult to send the cooling air to the flow passages Fc2, Fc3 formed inside the coils because of interruption by the lower portion of the core 3 and the supporting structural member 4. Namely, even if such an air-flow guide or windshield plate is simply placed, mostly the outside of the coils 2 is cooled, so that the inside (core 3-side) of the coils 2 could not be cooled efficiently. Thus, in order to enhance the efficiency of heat-dissipation from the surface of the reactor, it is necessary to enlarge the reactor to thereby make the surface area of the reactor larger. Instead, it is necessary to ensure required cooling air by increasing the resistance of Fc1 up to a level of that of Fc2 or Fc3 using a windshield as well as increasing the capacity of a blower (air flow volume, air flow pressure) so as to compensate against an increasing portion of the resistance.

However, in the air-cooled reactor 100 according to Embodiment 1, the air holes 4h that penetrate in the vertical direction (z-direction) are formed in a horizontal surface (x-y plane)-portion of the supporting structural member 4, in particular, at the positions corresponding to the flow passages Fc2, Fc3 inside the coils 2. This causes the required cooling air to flow, by way of flow passages FcH passing the air holes 4h, toward the flow passages Fc2, Fc3 whose flow resistances are too high so that a sufficient flow volume could not be achieved only by simply increasing the resistance of the outer flow passage Fc1.

Because of this, it is possible to cause the required cooling air to flow also in the flow passages Fc2, Fc3 inside the coils 2 without increasing the capacity of the blower, so that the coils 2 can be cooled also from inside thereof and thus becomes able to be cooled efficiently. As a result, the outer surface area of the reactor portion 1 is not required to be made larger, so that it is possible to downsize the reactor portion 1.

Note that, as described above, in order to ensure the insulating distance, it is necessary for the windshield plate 8 to use an insulating material such as a phenol resin, and the material has to have mechanical strength, durability and thermal stability, in combination. In contrast, because of the formation of the windshield plate 8, the wind tunnel 9 can be placed with the provision of a sufficient insulating distance from the reactor portion 1, and thus may have electric conductivity, so that it may be formed of an easily machinable metal material, such as an iron plate, a hot-dip zinc-aluminum-magnesium-alloy-plated corrosion-resistant steel plate, a SUS plate, or the like.

Note that the wind tunnel 9 serves to restrict flow passages of the cooling air to the spaces inside the reactor portion 1 (flow passages Fc2, Fc3) and the flow passage Fc1 in the outer surface side of the reactor portion 1, and is thus required to be placed at a position about 10 to 100 mm apart from the outer circumference of the reactor portion 1. If it is too much apart from the circumference, even when the gap of Fc1 is formed near the reactor portion 1 using the windshield plate 8, the cooling air mostly flows along the wall surface of the wind tunnel 9, so that the effect of enhancing the flow speed is reduced.

Further, the windshield plate 8 has such a structure that covers 10 to 60% of the area of the upper opening of the wind tunnel 9 and that is placed at a position corresponding to 10 to 120% of the height of the coils 2 of the reactor portion 1. If the area of the upper opening of the wind tunnel 9 is too much covered with the windshield plate 8, the pressure loss becomes larger, resulting in insufficiency of the air flow volume. Further, if the windshield plate 8 is largely apart from the upper surface of the coils 2, heat is accumulated in the wind tunnel 9, and the fluid resistance of the flow passage Fc1 at the outer surface side of the reactor portion 1 decreases so that the fluid resistance of the flow passages Fc2, Fc3 inside the reactor portion 1 (in the coils 2) relatively increases, and thus, the windshield plate 8 does not make sense.

The reactor portion 1 in the wind tunnel 9 may instead be two or more plural number of reactor portions, and in the case of the two or more plural number, when the respective reactor portions 1 are placed in the right-left direction with a placement interval of about 5 to 50 mm, an effect similar to that in the case of partitioning an air passage by the wind tunnel 9 can be achieved.

As described above, in accordance with the air-cooled reactor 100 according to Embodiment 1, it is configured to include: the core 3 (in a looped form) having the mutually-facing leg portions 3c with an interval therebetween and the yoke portions 3t, 3b that connect together respective both ends of the mutually-facing leg portions 3c; the coils 2 that forma pair and are so placed as to surround the mutually-facing leg portions 3c, respectively; the wind tunnel 9 that, while keeping an insulating distance to the pair-forming coils 2, surrounds a region from one (3b) of the yoke portions to at least a part of the pair-forming coils 2, to thereby guide a flow of cooling air for the pair-forming coils 2 into an extending direction of the leg portions 3c; the supporting structural member 4 that is fixed to said one yoke portion 3b to support, inside the wind tunnel 9, the core 3 and the pair-forming coils 2; and the windshield plate 8 that partly shields (is placed as it protrudes from the wind tunnel 9 toward the pair-forming coils 2 so as to partly shields) a gap (flow passage Fc1) between the pair-forming coils 2 and the wind tunnel 9; wherein, in the pair-forming coils 2, respective inner spaces (flow passages Fc2, Fc3) are formed respectively between the coils and the leg portions 3c, and inside of the coils 2, that extend in the extending direction of the leg portions 3c; and wherein, in the supporting structural member 4, the air holes 4h for passing the cooling air therethrough are formed corresponding to the inner spaces (flow passages Fc2, Fc3). Thus, it is possible to provide the air-cooled reactor 100 which can lessen the deviation of the cooling air along the radial direction of the coils 2, and thus, can be cooled efficiently.

In particular, the windshield plate 8 is so placed as to shield 10 to 60% portion of the gap (flow passage Fc1) between the pair-forming coils 2 and the wind tunnel 9. Thus, it is possible to optimize the speed of flow toward the flow passage Fc1 outside of the coils and the ratio of flow volume thereof relative to that of the inner flow passages Fc2, Fc3.

Furthermore, the windshield plate 8 is configured so that it is placed at a position in the extending direction of the leg portions 3c, said position corresponding to 10 to 120% of the length (height) of the pair-forming coils 2 and being apart from an end side of the coils 2 placed in the side of the yoke portion 3b toward the yoke portion 3t. Thus, it is possible to optimize the speed of flow toward the flow passage Fc1 outside of the coils, effectively.

In addition, since the yoke portion 3b is mounted as it being positioned at the under side of the leg portions 3c so that the extending direction of the leg portions 3c is given as the vertical direction, the cooling air smoothly flows upward from the under side.

As a specification of the air-cooled reactor 100 shown in this embodiment, such a specification is assumed that is applied to a power source of an ozone generator in which ozone is generated by discharging in an oxygen-containing gas. As a specific specification, such a specification is assumed in which the circuit voltage is set to 600V or more, the rated current is set to 5 to 100 A, and the drive frequency is set to 500 to 5 kHz. In this case, corresponding to the capacity, the weight is also heavy as being several tenths kg; and corresponding to the drive frequency, the loss (heat generation) becomes large. Thus, it is possible to exert the aforementioned effect to more extent. Note that the ozone generator is just one of well-suited application examples, and thus, this invention is not limited thereto.

### Embodiment 2

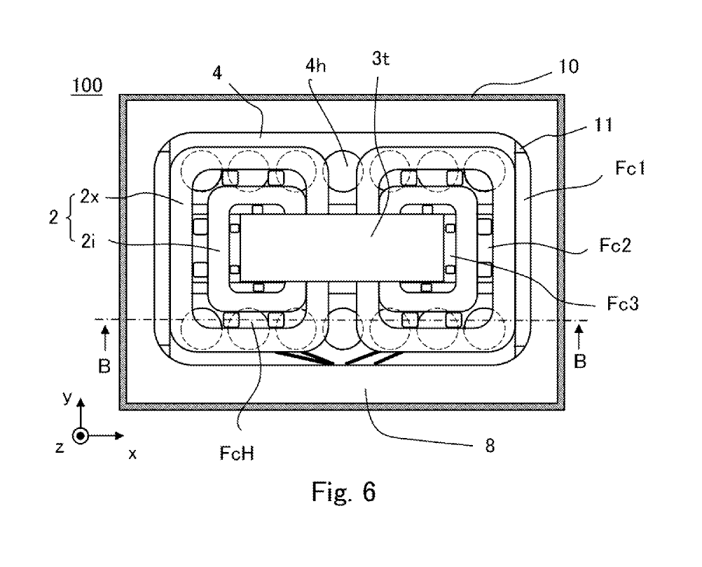

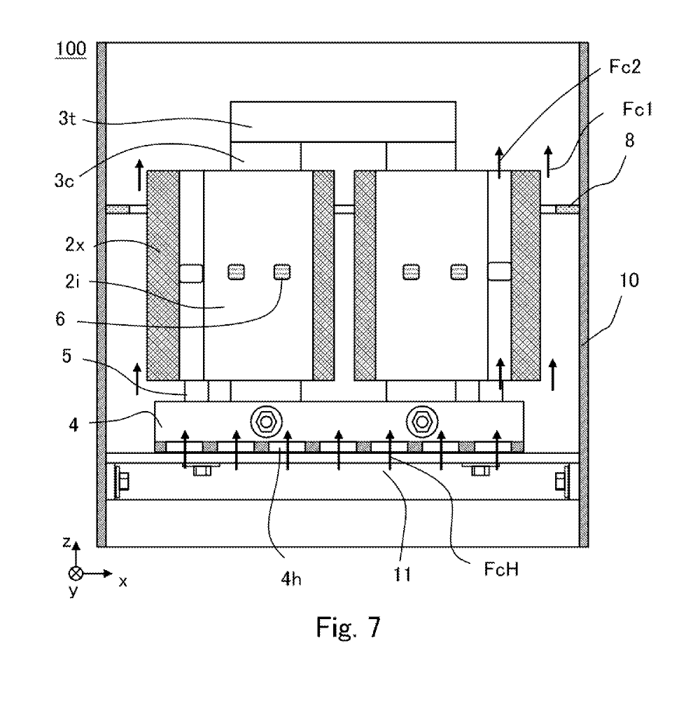

In Embodiment 1, a wind tunnel dedicated to the reactor portion is formed, whereas in Embodiment 2, attention is focused on a fact that from the relationship about the insulating distance, the wind tunnel is allowed to be formed of a metal, so that the housing that stores the reactor portion is, by itself, used as the wind tunnel. FIG. 6 and FIG. 7 are for illustrating an air-cooled reactor according to Embodiment 2 of the invention, in which FIG. 6 is a top view of the air-cooled reactor, and FIG. 7 is a sectional view according to the line B-B in FIG. 6, which is a sectional view of the air-cooled reactor when viewed from the front side. Note that the same reference numerals are given to the parts similar to the parts described in Embodiment 1, so that their description is omitted here.

As shown in FIG. 5 and FIG. 6, in the air-cooled reactor 100 according to Embodiment 2, a wind tunnel is shaped using the portions of front side, backside and both lateral sides of a housing 10 of the air-cooled reactor 100. The housing 10 serves to store the whole parts so as to cause the air-cooled reactor 100 to self-stand. Thus, the housing is formed of a material that is higher in mechanical strength than the material required for the wind tunnel 9 described in Embodiment 1, and supports, by way of a pedestal 11 fixed to its side surfaces, the supporting structural member 4 (weight of the reactor portion 1).

Further, also in Embodiment 2, like Embodiment 1, the inner surface of the housing 10 serving as a wind tunnel is placed at a position about 10 to 100 mm apart from the outer circumference of the reactor portion 1. Further, the windshield plate 8 has such a structure that covers 10 to 60% of the area of the upper opening and that is placed at a position corresponding to 10 to 120% of the height of the coils 2 of the reactor portion 1. Namely, according to Embodiment 2, the wind tunnel 9 dedicated to the reactor portion 1 can be omitted.

As described above, in accordance with the air-cooled reactor 100 according to Embodiment 2, at least a part of the wind tunnel (in this embodiment, parts all around) is formed of the inner surface of the housing 10 that stores the air-cooled reactor 100, so that the wind tunnel 9 dedicated to the reactor portion 1 can be omitted.

### Embodiment 3

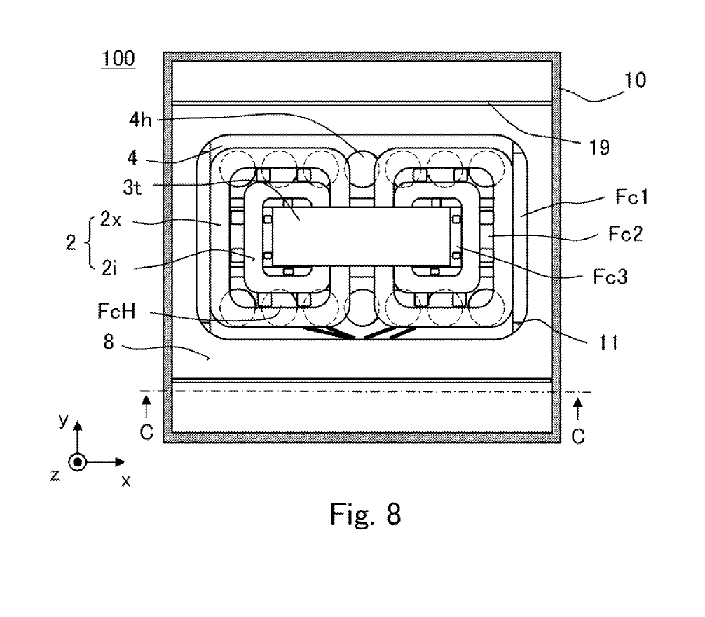

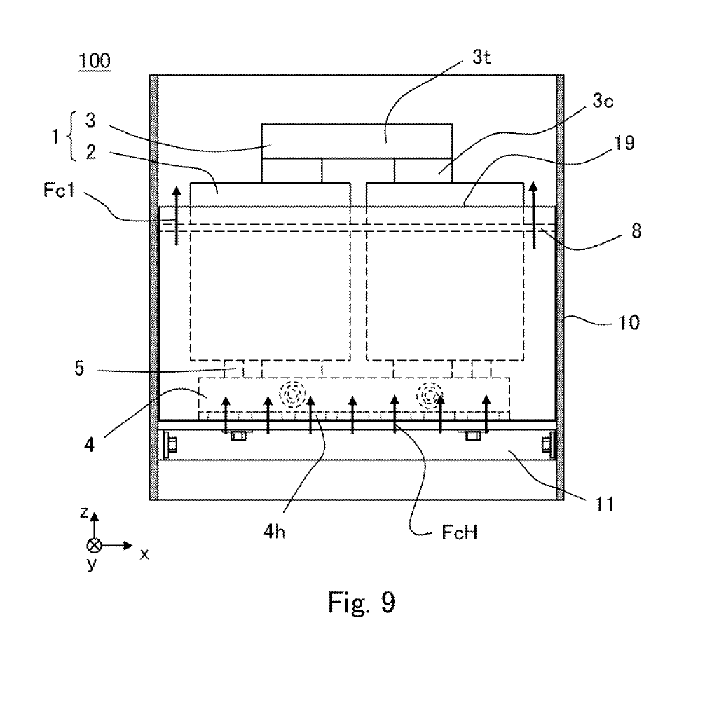

In Embodiment 2, all surfaces (four surfaces) of the wind tunnel for surrounding the reactor portion are substituted with the inner surface of the housing, whereas in Embodiment 3, the side surfaces (two surfaces) thereof are substituted with an inner surface (side surfaces) of the housing. FIG. 8 and FIG. 9 are for illustrating an air-cooled reactor according to Embodiment 3 of the invention, in which FIG. 8 is a top view of the air-cooled reactor, and FIG. 9 is a sectional view according to the line C-C in FIG. 8, which is a sectional view of the air-cooled reactor when viewed from the front side. Note that the same reference numerals are given to the parts similar to the parts described in Embodiment 1 or 2, so that their description is omitted here.

As shown in FIG. 8 and FIG. 9, in the air-cooled reactor 100 according to Embodiment 3, a wind tunnel is configured by forming dedicated wind-tunnel members 19 in the front and back sides of the reactor portion 1. This makes it possible in Embodiment 3 to omit a part of the wind tunnel 9 dedicated to the reactor portion.

Further, also in Embodiment 3, like Embodiment 1 or 2, the side surfaces (inner surface) of the housing 10 serving as a wind tunnel and the wind-tunnel members 19 are placed at a position about 10 to 100 mm apart from the outer circumference of the reactor portion 1. Further, the windshield plate 8 has such a structure that covers 10 to 60% of the area of the upper opening and that is placed at a position corresponding to 10 to 120% of the height of the coils 2 of the reactor portion 1.

As described above, in accordance with the air-cooled reactor 100 according to Embodiment 3, at least a part of the wind tunnel (in this embodiment, side surfaces) is formed of an inner surface of the housing 10 that stores the air-cooled reactor 100, so that the wind tunnel 9 dedicated to the reactor portion 1 can be partly omitted.

### Embodiment 4

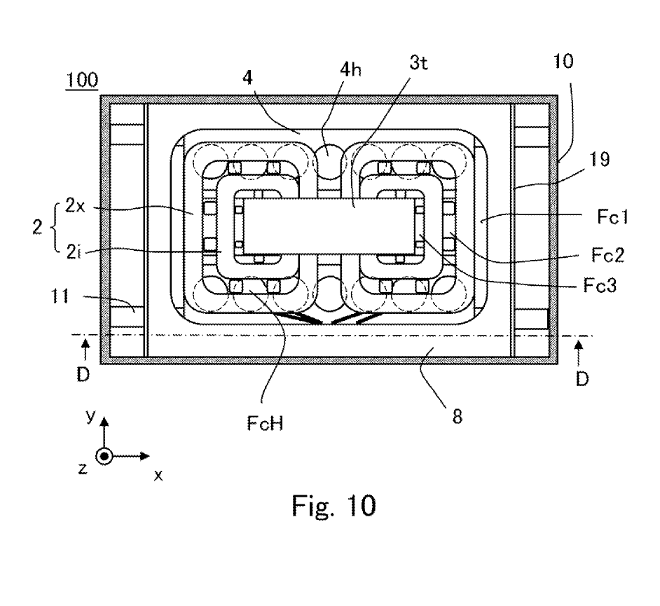

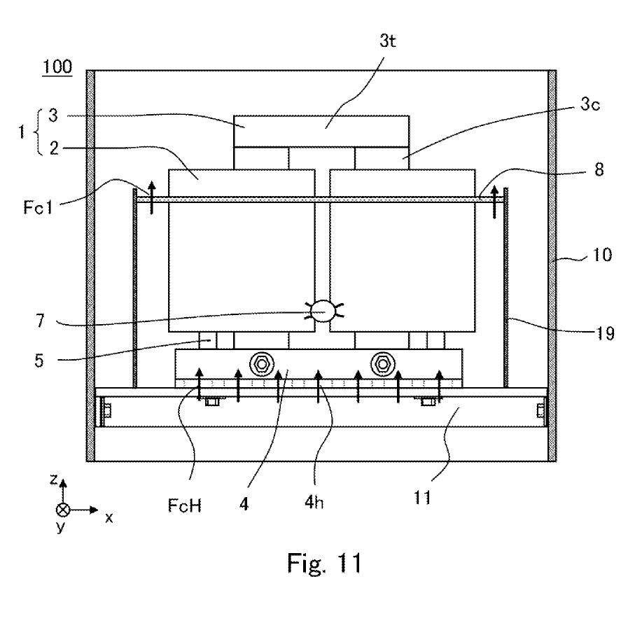

In Embodiment 2, all surfaces (four surfaces) of a wind tunnel for surrounding the reactor portion are substituted with the inner surface of the housing, whereas in Embodiment 4, the front surface and the back surface (two surfaces) are substituted with an inner surface of the housing. FIG. 10 and FIG. 11 are for illustrating an air-cooled reactor according to Embodiment 4 of the invention, in which FIG. 10 is a top view of the air-cooled reactor, and FIG. 11 is a sectional view according to the line D-D in FIG. 10, which is a sectional view of the air-cooled reactor when viewed from the front side. Note that the same reference numerals are given to the parts similar to the parts described in Embodiments 1 to 3, so that their description is omitted here.

As shown in FIG. 10 and FIG. 11, in the air-cooled reactor 100 according to Embodiment 4, a wind tunnel is configured by forming dedicated wind-tunnel members 19 in the lateral sides of the reactor portion 1. This makes it possible in Embodiment 4 to omit apart of the wind tunnel 9 dedicated to the reactor portion.

Further, also in Embodiment 4, like Embodiments 1 to 3, the front surface and the back surface (inner surface) of the housing 10 serving as a wind tunnel and the wind-tunnel members 19 are placed at a position about 10 to 100 mm apart from the outer circumference of the reactor portion 1. Further, the windshield plate 8 has such a structure that covers 10 to 60% of the area of the upper opening and that is placed at a position corresponding to 10 to 120% of the height of the coils 2 of the reactor portion 1.

As described above, in accordance with the air-cooled reactor 100 according to Embodiment 4, at least apart of the wind tunnel (in this embodiment, front surface and back surface) is formed of an inner surface of the housing 10 that stores the air-cooled reactor 100, so that the wind tunnel 9 dedicated to the reactor portion 1 can be partly omitted.

### DESCRIPTION OF REFERENCE NUMERALS AND SIGNS

1: reactor portion, 2: coils, 2i: inner layer of coil, 2x: outer layer of coil, 3: core, 3b: yoke portion (bottom side), 3c: leg portions, 3t: yoke portion (top side), 4: supporting structural member, 4h: air holes, 5: coil supporting members, 6: spacers, 8: windshield plate, 9: wind tunnel, 10: housing, 11: pedestal, 19: wind-tunnel members, 100: air-cooled reactor, Fc1: flow passage outside the reactor portion, Fc2, Fc3: flow passages inside the coil (inner spaces), FcH: flow passage in air hole portion.

1-5. (canceled)

6. An air-cooled reactor, comprising:
a core having mutually-facing leg portions with an interval therebetween and yoke portions that connect together respective both ends of the mutually-facing leg portions;
coils that form a pair and are so placed as to surround the mutually-facing leg portions respectively;
a wind tunnel that, while keeping an insulating distance to the pair-forming coils, surrounds a region from one of the yoke portions to at least a part of the pair-forming coils, to thereby guide a flow of cooling air for the pair-forming coils into an extending direction of the leg portions;
a supporting structural member that is fixed to said one of the yoke portions to support, inside the wind tunnel, the core and the pair-forming coils; and
a windshield plate that partly shields a gap between the pair-forming coils and the wind tunnel;
wherein, in the pair-forming coils, inner spaces are formed respectively between the coils and the leg portions or inside of the coils, that extend in the extending direction of the leg portions; and
wherein, in the supporting structural member, air holes for passing the cooling air therethrough are formed corresponding to the inner spaces.

7. The air-cooled reactor according to claim 6, wherein the windshield plate is so placed as to shield 10 to 60% portion of the gap between the pair-forming coils and the wind tunnel.

8. The air-cooled reactor according to claim 6, wherein the windshield plate is placed at a position in the extending direction of the leg portions, said position corresponding to 10 to 120% of a length of the pair-forming coils and being apart from an end side of that coils placed in the side of said one of the yoke portions toward the other of the yoke portions.

9. The air-cooled reactor according to claim 7, wherein the windshield plate is placed at a position in the extending direction of the leg portions, said position corresponding to 10 to 120% of a length of the pair-forming coils and being apart from an end side of that coils placed in the side of said one of the yoke portions toward the other of the yoke portions.

10. The air-cooled reactor according to claim 6, wherein at least a part of the wind tunnel is formed of an inner surface of a housing that stores the air-cooled reactor.

11. The air-cooled reactor according to claim 7, wherein at least a part of the wind tunnel is formed of an inner surface of a housing that stores the air-cooled reactor.

12. The air-cooled reactor according to claim 8, wherein at least a part of the wind tunnel is formed of an inner surface of a housing that stores the air-cooled reactor.

13. The air-cooled reactor according to claim 9, wherein at least a part of the wind tunnel is formed of an inner surface of a housing that stores the air-cooled reactor.

14. The air-cooled reactor according to claim 6, wherein its circuit voltage is set to 600V or more, its rated current is set to 5 to 100 A, and its drive frequency is set to 500 to 5 kHz.

15. The air-cooled reactor according to claim 7, wherein its circuit voltage is set to 600V or more, its rated current is set to 5 to 100 A, and its drive frequency is set to 500 to 5 kHz.

16. The air-cooled reactor according to claim 8, wherein its circuit voltage is set to 600V or more, its rated current is set to 5 to 100 A, and its drive frequency is set to 500 to 5 kHz.

17. The air-cooled reactor according to claim 9, wherein its circuit voltage is set to 600V or more, its rated current is set to 5 to 100 A, and its drive frequency is set to 500 to 5 kHz.

18. The air-cooled reactor according to claim 10, wherein its circuit voltage is set to 600V or more, its rated current is set to 5 to 100 A, and its drive frequency is set to 500 to 5 kHz.

19. The air-cooled reactor according to claim 11, wherein its circuit voltage is set to 600V or more, its rated current is set to 5 to 100 A, and its drive frequency is set to 500 to 5 kHz.

20. The air-cooled reactor according to claim 12, wherein its circuit voltage is set to 600V or more, its rated current is set to 5 to 100 A, and its drive frequency is set to 500 to 5 kHz.

21. The air-cooled reactor according to claim 13, wherein its circuit voltage is set to 600V or more, its rated current is set to 5 to 100 A, and its drive frequency is set to 500 to 5 kHz.
